(19) United States
(12) Patent Application Publication
(10) Pub. No.: US 2022/0164177 A1
(43) Pub. Date: May 26, 2022

(54) SYSTEMS AND METHODS FOR MANAGING CONTAINERIZED APPLICATIONS ON AN EDGE DEVICE

(71) Applicant: SIGHTHOUND, INC., Winter Park, FL (US)

(72) Inventors: Daniel Jay WALKES, Superior, CO (US); David Andres Alejandro SOTO MORA, Superior, CO (US)

(21) Appl. No.: 17/534,568

(22) Filed: Nov. 24, 2021

Related U.S. Application Data
(60) Provisional application No. 63/117,587, filed on Nov. 24, 2020.
(60) Provisional application No. 63/117,588, filed on Nov. 24, 2020.

(51) Int. Cl. G06F 8/65; G06F 9/4401; G06N 5/02; H04L 41/22; H04L 41/16; H04L 41/082

(52) U.S. Cl. CPC G06F 8/65; G06F 9/4401; H04L 41/082; H04L 41/22; H04L 41/16; G06N 5/022

(57) ABSTRACT

Methods and apparatuses implement docker containers with an application store involved in deployment of the containers. Implementation of the containers may be performed via remote controlling means, and the containers may be subsequently updated, including firmware updates.

### CROSS-REFERENCE TO RELATED APPLICATIONS

This application claims the benefit of U.S. Provisional Application No. 63/117,587 filed on Nov. 24, 2020 and entitled “Systems and Methods for Managing Containerized Applications on an Edge Device” and U.S. Provisional Application No. 63/117,588 filed on Nov. 24, 2020 and entitled “Systems and Methods for Managing Containerized Applications on an Edge Device,” the contents of both being incorporated by reference herein in their entireties.

### BACKGROUND

Application containers allow applications (apps) to run on disparate software environments, while isolating the environment of the app from other apps and from the host system. Apps are typically preloaded via ad hoc setup.

Edge or Internet of things (IoT) devices may be limited in comparison to contemporary hardware (e.g., a personal computer, a laptop computer, a notebook computer, a work station, a server, a high performance computer (HPC), etc.). The firmware of such devices are typically upgraded via plugging-in a USB cable and putting them in recovery mode. Further, hosted application is known to host payload files that an app can download and automatically process it.

User devices comprise hardware operably capable of executing software beyond manufacturers' development teams. Third parties thus develop custom apps, creating a need for implementing an app store for edge and IoT devices.

### SUMMARY

Systems and methods are disclosed for a docker engine to obtain a container, e.g., for updating firmware of an edge device, whereas another container may be obtained for updating containerized software of a plurality of different parties. Accordingly, one or more aspects of the present disclosure relates to a method for controlling and/or querying, via a cloud server, and/or responsively-receiving, via an edge engine of a user device communicably coupled to the cloud server, information of a container engine executing on the user device. The method may also include a step of pulling, from the app store, and/or controlling, via the container engine, a container of an application such that a machine learning model operably generates data.

The method may also be implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

In order to facilitate a fuller understanding of the invention, reference is now made to the accompanying drawings, in which like elements are referenced with like numerals. These drawings should not be construed as limiting the invention and intended only to be illustrative.

FIG. 1A illustrates a system diagram of an exemplary, networked edge device.

FIG. 1B illustrates a block diagram of exemplary computing peripherals of the edge device.

FIG. 2 illustrates an architecture for deploying and updating containerized software according to an aspect of the application.

FIGS. 3-4 illustrate exemplary user interfaces for configuring and querying edge devices in deployment.

FIG. 5 illustrates an exemplary process for deploying containerized apps, including their downloading from an app store.

FIG. 6 illustrates an exemplary process for deploying containerized apps, including their updating.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

### Device and Network Architecture

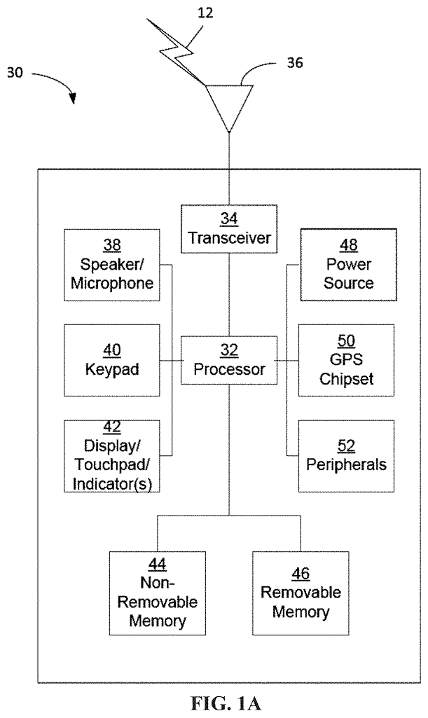

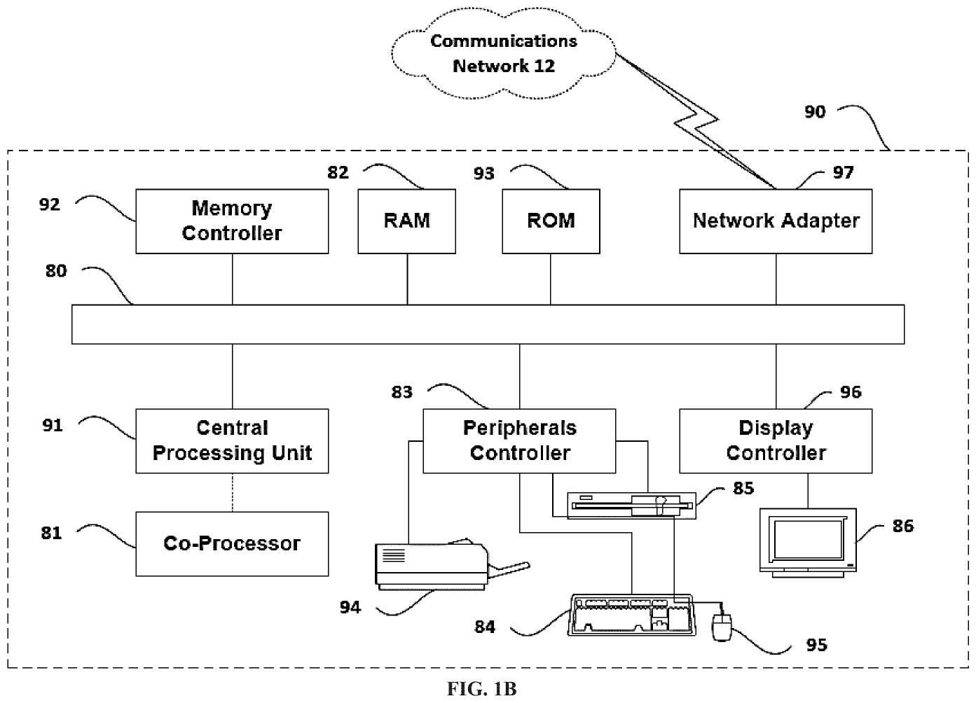

FIG. 1A is a block diagram of an exemplary hardware/software architecture of edge device 30 of a network, such as clients, servers, or proxies, which may operate as an server, gateway, device, or other edge device in a network. Edge device 30 may include processor 32, non-removable memory 44, removable memory 46, speaker/microphone 38, keypad 40, display, touchpad, and/or indicators 42, power source 48, global positioning system (GPS) chipset 50, and other peripherals 52. Edge device 30 may also include communication circuitry, such as transceiver 34 and transmit/receive element 36. Edge device 30 may include any sub-combination of the foregoing elements while remaining consistent with an embodiment.

Processor 32 may be a general purpose processor, a special purpose processor, a conventional processor, a digital signal processor (DSP), a plurality of microprocessors, one or more microprocessors in association with a DSP core, a controller, a microcontroller, application specific integrated circuits (ASICs), field programmable gate array (FPGAs) circuits, any other type of integrated circuit (IC), a state machine, and the like. In general, the processor 32 may execute computer-executable instructions stored in the memory (e.g., memory 44 and/or memory 46) of edge device 30 in order to perform the various required functions of edge device 30. For example, the processor 32 may perform signal coding, data processing, power control, input/output processing, and/or any other functionality that enables edge device 30 to operate in a wireless or wired environment. Processor 32 may run application-layer programs (e.g., browsers) and/or radio-access-layer (RAN) programs and/or other communications programs. The processor 32 may also perform security operations, such as authentication, security key agreement, and/or cryptographic operations. The security operations may be performed, for example, at the access layer and/or application layer.

As shown in FIG. 1A, processor 32 is coupled to its communication circuitry (e.g., transceiver 34 and transmit/receive element 36). Processor 32, through the execution of computer-executable instructions, may control the communication circuitry to cause edge device 30 to communicate with other edge devices via the network to which it is connected. While FIG. 1B depicts processor 32 and transceiver 34 as separate components, processor 32 and the transceiver 34 may be integrated together in an electronic package or chip.

Transmit/receive element 36 may be configured to transmit signals to, or receive signals from, other edge devices, including servers, gateways, wireless devices, and the like. For example, in an embodiment, transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, transmit/receive element 36 may be configured to transmit and receive both RF and light signals. Transmit/receive element 36 may be configured to transmit and/or receive any combination of wireless or wired signals.

In addition, although the transmit/receive element 36 is depicted in FIG. 1A as a single element, edge device 30 may include any number of transmit/receive elements 36. More specifically, edge device 30 may employ multiple-input and multiple-output (MIMO) technology. Thus, in an embodiment, edge device 30 may include two or more transmit/receive elements 36 (e.g., multiple antennas) for transmitting and receiving wireless signals.

The transceiver 34 may be configured to modulate the signals to be transmitted by the transmit/receive element 36 and to demodulate the signals that are received by the transmit/receive element 36. As noted above, edge device 30 may have multi-mode capabilities. Thus, the transceiver 34 may include multiple transceivers for enabling edge device 30 to communicate via multiple RATs, such as Universal Terrestrial Radio Access (UTRA) and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on edge device 30, such as on a server or a home computer.

The processor 32 may receive power from the power source 48, and may be configured to distribute and/or control the power to the other components in edge device 30. The power source 48 may be any suitable device for powering edge device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of edge device 30. Edge device 30 may acquire location information by way of any suitable location-determination method while remaining consistent with an embodiment.

The processor 32 may further be coupled to other peripherals 52, which may include one or more software and/or hardware modules that provide additional features, functionality, and/or wired or wireless connectivity. For example, the peripherals 52 may include various sensors such as an accelerometer, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, an Internet browser, and the like.

Edge device 30 may be embodied in other apparatuses or devices. Edge device 30 may connect to other components, modules, or systems of such apparatuses or devices via one or more interconnect interfaces, such as an interconnect interface that may comprise one of the peripherals 52.

FIG. 1B is a block diagram of an exemplary computing system 90 that may be used to implement one or more edge devices (e.g., clients, servers, or proxies) of a network, and which may operate as a server, gateway, device, or other edge device in a network. The computing system 90 may comprise a computer or server and may be controlled primarily by computer-readable instructions, which may be in the form of software, by whatever means such software is stored or accessed. Such computer-readable instructions may be executed within a processor, such as a central processing unit (CPU) 91, to cause computing system 90 to effectuate various operations. In many known workstations, servers, and personal computers, the CPU 91 is implemented by a single-chip CPU called a microprocessor. In other machines, the CPU 91 may comprise multiple processors, including graphics processing units (GPUs). Co-processor 81 is an optional processor, distinct from CPU 91 that performs additional functions or assists the CPU 91.

In operation, CPU 91 fetches, decodes, executes instructions, and transfers information to and from other resources via the computer's main data-transfer path, system bus 80. Such system bus 80 connects the components in the computing system 90 and defines the medium for data exchange. System bus 80 typically includes data lines for sending data, address lines for sending addresses, and control lines for sending interrupts and for operating system bus 80. An example of such system bus 80 is the peripheral component interconnect (PCI) bus.

Memories coupled to system bus 80 include RAM 82 and ROM 93. Such memories include circuitry that allows information to be stored and retrieved. ROM 93 generally contains stored data that cannot easily be modified. Data stored in RAM 82 may be read or changed by CPU 91 or other hardware devices. Access to RAM 82 and/or ROM 93 may be controlled by a memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space. It cannot access memory within another process's virtual address space unless memory sharing between the processes has been set up.

In addition, the computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

### Docker Engine

Docker is a set of platform as a service (PaaS) products that use OS-level virtualization to develop, ship, and run software in packages or containers. The software that hosts the containers may be a docker engine. A docker engine may comprise a client and server, communicably coupled via a high-level (e.g., representational state transfer (REST)) application programming interface (API). The client may run commands, each of which being translated using REST API and sent to the server (docker daemon). A docker daemon may check a client request and interact with an OS (e.g., Linux, Windows, mac OS, or another operating system) to create and/or manage containers. Other components of docker may comprise the images and a registry (e.g., for hosting and distributing images) or repository of stored (e.g., in a hub) docker images.

Push (e.g., upload built images) and pull (e.g., download images for use) commands may be used to interact with a docker registry. For example, the herein-disclosed docker engine may pull from an app store repository a docker container, which may then be run locally at an edge device.

As used herein, an edge or IoT device may be a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a vehicle (e.g., embedded computer, such as in a dashboard or in front of a seated occupant of a car or plane), a game or entertainment system, a set-top-box, a monitor, a television (TV), a panel, a space craft, or any other device. In some embodiments, a processor of system 10 (e.g., in edge device 145 or another component communicably coupled thereto) may be configured to provide information processing capabilities. The processor may comprise one or more of a digital processor, an analog processor, a digital circuit designed to process information, an analog circuit designed to process information, a state machine, and/or other mechanisms for electronically processing information. In some embodiments, the processor may comprise a plurality of processing units. These processing units may be physically located within the same device (e.g., edge device 145), or the processor may represent processing functionality of a plurality of devices operating in coordination (e.g., one or more servers, user interface devices, devices that are part of external resources, electronic storage, and/or other devices).

The docker client may have a command line interface (CLI) and be accessed from a terminal. A docker host may run the docker daemon (which may interact with the docker containers and images) and interact with the registry. Users of system 10 may build docker images and run the containers by passing commands from the client to the server. Docker images may be templates, each having instructions for creating the containers, and built using a docker file. A docker image may be a read-only template used to build containers, and it may be used to store and ship applications.

In some embodiments, docker containers may be standalone, executable packages comprising dependencies (e.g., software, libraries, and configuration files) required to run and/or maintain isolated applications. In an example, each application may be on a same hardware and share an OS with other lightweight containers, effectively using fewer resources than virtual machines. For example, a single server or virtual machine can run several containers simultaneously.

The disclosed approach may exhibit productivity gains by providing a consistent environment to easily onboard new developers and via automation (e.g., builds and/or tests). Containers may package up code and its dependencies so that the application runs quickly and reliably from one computing environment to another. By comparison, Internet protocol (IP) frames are typically much smaller than a container, e.g., with containers ranging in size based on function. For example, a container may range from tens of megabytes (MB) to tens of gigabytes (GB).

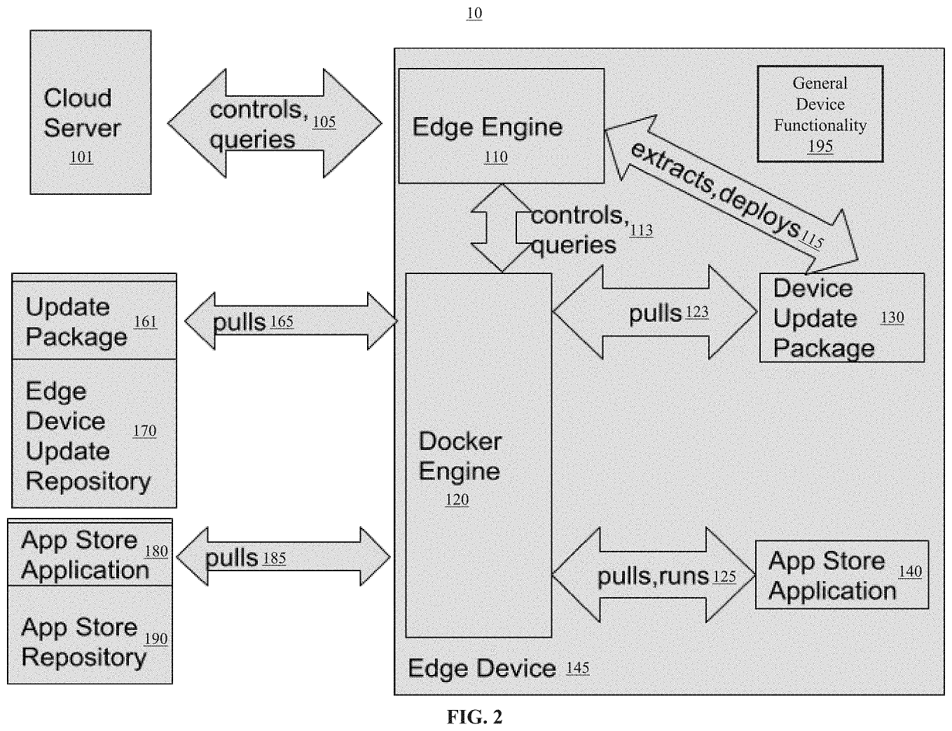

In some embodiments, system 10 of FIG. 2 may implement security at applications (apps) running on the edge device. In these or other embodiments, the security activities may involve confirming whether each app expectedly operates within identified parameters.

Herein-disclosed security measures enable support of third parties that deploy software on an entity's platform, such as at edge device 145. For example, execution of the apps may be made suitable for a particular deployment scheme. In some embodiments, implementations involving docker may automate deployment of apps in a light weight container such that an app works efficiently in a different environment. An existing app may be built within a docker container instead of the host OS, e.g., with build artifacts placed in a deployment container. The multi-stage build process supported by docker may allow a build stage to have additional dependencies not needed for deployment, while the deploy container has the minimum dependencies required for deployment.

Third parties typically develop apps that are not specific to edge device 145, e.g., with proprietary libraries for artificial intelligence (AI). The herein-disclosed approach obtains existing software running on a different environment yet based on a similar architecture and packages that up in a format such that substantially the same software runs on edge device 145, which may be running a different, customized OS version (e.g., of Linux). For example, an execution environment may match a development environment yet on a completely different hardware platform.

FIG. 2 depicts edge device 145 with a container (e.g., Docker) engine environment 120 that may provide a mechanism for delivery, update, and control of application containers.

FIG. 2 depicts app store repository 190, e.g., which may comprise a repository of docker containers. Also depicted therein is cloud server 101, e.g., which may comprise a platform for obtaining status about edge device 145 and for controlling/querying 105 with this device. For example, AI models, which are to run on hardware (e.g., of edge device 145 and/or at cloud server 101) may be controlled and their state queried. Such command and status interfacing may be implemented via controls, queries 113 at least between edge engine 110 and docker engine 120. The edge engine is mostly a relay/wrapper. The control essentially mirrors docker, e.g., pull to pull containers, start to start, stop to start, delete to delete. In some implementations, the status may query other content inside the container, e.g., the performance or resource utilization.

FIG. 2 depicts edge engine 110 extracting and deploying 115 from containers at device update package 130, the containers being pulled 123 via docker engine 120 (under control by edge engine 110). For example, a docker container may be pulled and executed. In this or another example, a docker container may be pulled and at least a portion of its content extracted to perform an update of edge device 145. The terms package and container may be used synonymously herein.

In some embodiments, edge engine 110 may perform a differencing scheme, e.g., to determine what needs to get updated in the container. For example, edge engine 110 may analyze on a per file level about what is different with each file, and then provide a difference that contains any of the changed files. In this or another example having one large, compressed file (e.g., 1.5 GB in size), the docker update may be another large, compressed file (e.g., 1.5 GB in size) that has changed, with only about 1-50 MB being actually changed. Edge engine may thus extract that identified portion that changed, and a respective container pull may only be performed for the difference needed (e.g., for a package being updated).

In some embodiments, the edge engine may enable, with respect to the cloud server, controlling activities of containers and perform queries of the containers at docker engine 120. As such, the edge engine may wrap around docker utilities to manipulate the containers to provide needed functionality, e.g., including how a docker engine runs, which containers are running, and querying status about the current execution environment for docker. The wrapping may be implemented through docker-compose, where the compose file contains a list of services which need to be started for a specific application. Invoking ‘docker-compose up’ may start all containers and services associated with a given application. Invoking ‘docker-compose down’ may stop all containers. Invoking ‘docker-compose down --rmi’ may delete containers. The status wrapper parses the list of all containers comprising an application, and queries the docker engine for the status of each container. This may be used to build an overall status for the application.

In some embodiments, edge engine 110 may control what exactly is accessible, and how that query and access occurs. In these or other embodiments, the edge engine may control an ability to run specific apps on the app store.

In some embodiments, edge engine 110 may implement guardrails that control how data is obtained at the platform (e.g., via cloud server 101). For example, the edge engine may implement guardrails around the specific, running apps to make sure that each app only operates as expected. In this or another example, metadata may be output as JSON files in a directory inside the deployment container. There may be one JSON file per object or event. For instance, there may be one JSON file per each car that appears on a scene when tracking cars (e.g., tracking each object to avoid generating duplicate objects). Together with the JSON file generated, two images may be included, one of the bounding box and the other of the complete frame that give context to that bounding box.

In some embodiments, specifically formatted JSON files may be written, having the information to be communicated up to the platform. For example, from an AI container perspective, the platform may not be directly interacted, the network being accesses directly. Events that occur from an AI perspective may be obtained, the JSON file may be formatted with suitable fields, and then the file may be written to a directory such that other software relays data to the platform.

Further, the edge engine may implement quality assurance (QA) activities with respect to running apps via the herein-disclosed platform. For instance, the edge engine may ensure that an application starts successfully when requested. It may ensure that an application places output in locations where it is expected. It may ensure an application handles possible input combinations appropriately.

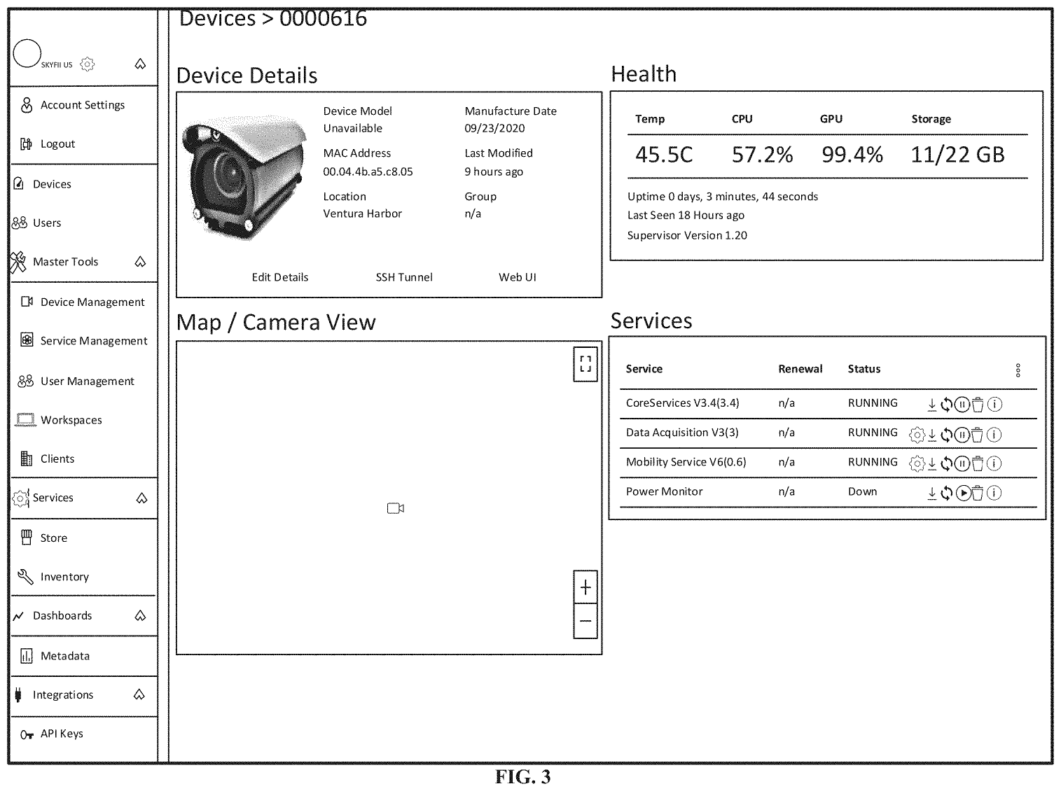

The edge engine framework may provide additional policy and mechanism to a container engine (e.g., Docker) for the purpose of deploying third party applications in a cloud hosted application store, which can then be deployed and run on edge device 145. The framework may include: (i) validating that a third party application meets policy requirements (e.g., where and/or how much persistent storage can be written by the application, how network access can be interacted by the application, how much processing resources and/or memory can be consumed by the application, etc.) through automated testing and compliance checks; (ii) configuring container engine 120, e.g., for appropriate repository access based on a policy controlled by cloud server 101; (iii) pulling and running third party applications on an edge device at the request of the cloud server; (iv) monitoring status of containers (e.g., temperature of a hardware component, CPU utilization, GPU utilization, storage utilization, or another parameter such as performance of processing in frames per second or a similar metric), interacting with a cloud server to support remote controlling (e.g., pause, stop, run, delete, restart, or another function, as shown in FIG. 3) and monitoring of each container's run state; and/or (v) deploying edge device firmware updates through an update repository with support for delta (e.g., comprising one or more changes from a previous version) updates.

The aforementioned policy requirements may include a policy requirement (or one or more rules) limiting how much an app may write, where it may write in persistent storage, how it may interact with the network, and/or another suitable constraint. For example, gates may be implemented to limit Internet access. In this or another example, when files are desired to be provided to the platform, the app may need to write a file to a specific location, which may then be passed on up through the platform. Another example of contemplated policy requirements may include requiring apps only to be able to use a certain amount of a CPU, GPU, and/or memory, when running. Such limiting of the apps may be implemented by edge engine 110 such that multiple applications are concurrently supported. Another example of this limiting may enable edge device 145 to still be able to function, when running a set of apps.

The aforementioned configuration of container engine 120, for appropriate repository access, is an example of herein-disclosed guardrails. Such functionality may largely be outside application control, e.g., by seamlessly performing it without user awareness or involvement. For example, edge engine 110 may establish control such that apps have exactly the access they need (e.g., precluding each app from having ability to download another container from a competing app from the app store). In this or another example, edge engine 110 may have exactly the access it needs to pull the components it needs from app store repository 190.

The aforementioned remote controlling may be on the container's run state, e.g., commanding it to pause, stop, run, and/or be deleted. FIG. 3 depicts this on a graphical user interface capable (GUI) of being displayed at the cloud server 101 or remotely at another server, The GUI displays general device functionality 195 including operation of a camera. For example, a container associated with a third party app may be paused, stopped, restarted, and/or otherwise controlled. In this or another example, one or more other aspects of the container may be configured.

In some embodiments, a user of cloud server 101 may interact at a user interface (UI) such that an edge device's power is controlled, settings are entered, a download operation is performed, command and/or status is refreshed, operation of the container is paused, the container is deleted, information is obtained, or another operational characteristic is implemented, as demonstrably shown in FIG. 3. Further depicted in FIG. 3 may be an environment captured in real-time by a sensor implemented at the edge device.

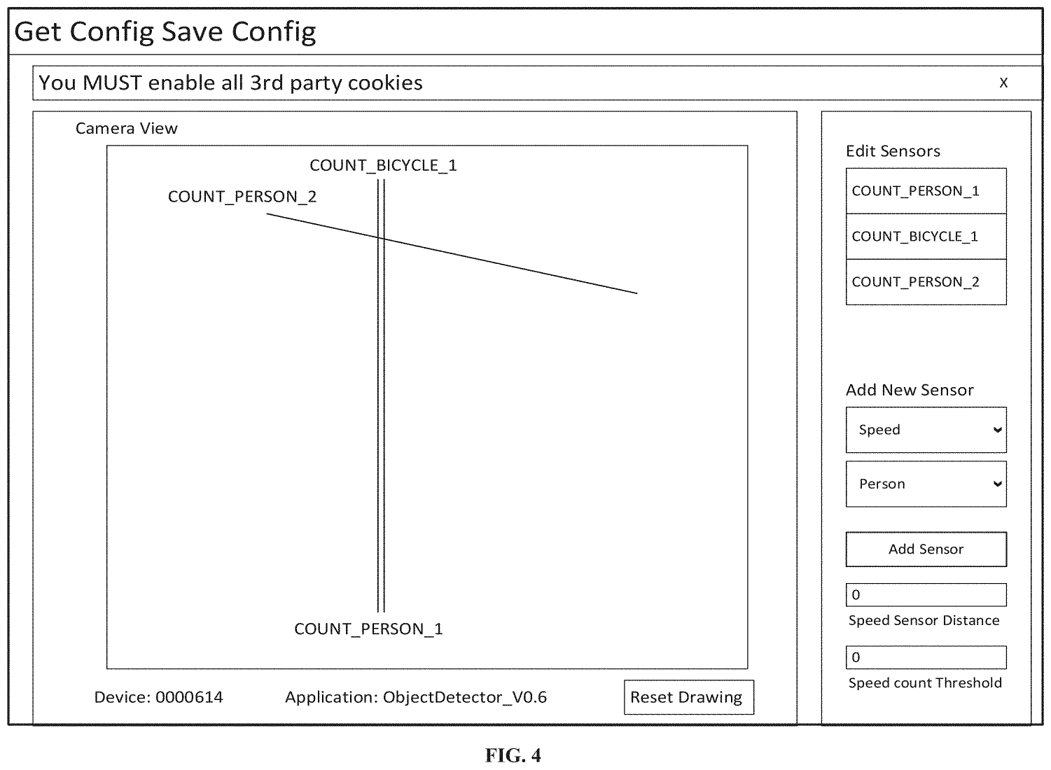

FIG. 4 depicts an example of how the herein-disclosed system may configure the container engine, e.g., by clicking a settings icon of a respective application or service depicted in FIG. 3. A trajectory of a person and/or vehicle (e.g., bicycle) may be tracked with respect to an environment of the person/vehicle, at a user interface accessible via cloud server 101. The COUNT_PERSON_1 sensor in FIG. 4 may create events when people cross the sensor in one direction or another, e.g., walking across a parking lot. These counts may be queried via cloud server or trajectories tracked. Similarly, for the COUNT_BICYCLE_1 sensor in FIG. 4, the number of bicycles crossing the line while progressing down the street may be counted, queried via the cloud server, and tracked via trajectories. The sensor at the edge device may further be controlled, e.g., with respect to its speed or person, as shown in FIG. 4.

The herein-disclosed approach combines the capabilities of docker engine and container deployment with capabilities for remote control and monitoring to implement the necessary requirements for an application store hosting third party applications. Exemplary requirements include the ability to install, start, stop, query or update applications on devices via a remote interface, the ability to send relevant status to a cloud server, and the ability to validate functionality and quality aspects of containerized applications. FIG. 3 provides an example of contemplated features that edge engine may be configured to monitor, e.g., indicating percent utilizations of both the GPU and CPU, a current health, a current amount of storage in use, a status of each of the containers, and/or another sensed parameter. In some embodiments, the edge engine or another component of system 10 may determine a set of rules to govern operational limits of the containerized application. In these or other embodiments, the edge engine or another component of system 10 may be configured to obtain and adjust current settings.

In some embodiments, an app store (or app marketplace, such as the one shown in FIG. 2), may be a platform for digital distribution of computer software apps, e.g., to mobile devices. Apps run on OSs to implement specific functions apart from functionality of the computer itself. The herein-discloses app store may allow searching (e.g., based on categories) and reviewing of offered software titles and/or other media. The store may automate purchase, decryption, and installation of the respective app or other media. In some embodiments, the app store may organize the offered apps based on respective function(s).

In some embodiments, app store app 180 may be hosted at or in relation to app store repository 190. App 180 may help facilitate the app store, including distribution of the containerized apps. In these or other embodiments, app store app 140 may be hosted at edge device 145 upon being pulled from repository 190 and execution of its binaries locally at device 145. In some embodiments, docker containers may be pulled 185 and/or run 125 between devices/systems of different parties using app store app 180. For example, one app may be run on a server, whereas another may be run at edge device 145.

In some embodiments, support for both application store deployments and edge device firmware updates means, e.g., that a single control plane can support both updates of application containers, including application containers developed internally and by partners, as well as updates of the base edge device firmware. The containers may not be stored in firmware, however in some embodiments container orchestration files, which reference specific containers, may be stored in firmware. This may allow specific container version(s) for applications to be associated with specific firmware version(s). In most cases, however, application versions are allowed to change independently of firmware versions.

In some embodiments, firmware for edge engine 110 may be updated, and other firmware for other software at edge device 145 may be updated. For example, docker engine 120 may pull a new container and run the container for the firmware of edge engine 110. In this or another example, the firmware may relate to general device functionality 195, e.g., implementing one or more sensors, or to other aspects of edge device 145, both of which being developed agnostic of docker implementation. In some embodiments, docker implementation of an app store may enable platform agnostic applications to be customized to perform the specific feature(s) required of the third party application. The containerization mechanism provides a platform-agnostic part. This means that the underlying device firmware can change, or the container can run on completely different hardware, but will still provide the same design functionality requirements.

In some embodiments, mechanisms for updating different components (e.g., of edge engine 110 and/or general device functionality 195) may be bundled inside a docker package. For example, the way containers are used may be customized such that they can deliver payloads for firmware updates.

And then edge engine 110 may identify presence of that package, from among other packages for apps implemented via docker, and tag it as an update package for subsequent processing. For example, edge engine 110 may extract and deploy the extracted data 115 (e.g., by writing some areas associated with device firmware and rebooting edge device 145), to deploy an update to the device. As such, edge engine 110 may distinguish between different use cases, including those involving edge device updates and app store updates.

In some embodiments, a machine learning (ML) platform may be implemented via coordination of edge engine 110 and container engine 120. The ML model may be a part of the application which implemented machine learning and which is run as 140. The coordination may really be the same coordination described above, pulling, starting, stopping, deleting, etc. The difference may be related to model management which could possibly be managed separately from the application. In these or other embodiments, the herein-disclosed system may support third party applications and/or device firmware updates, which may, e.g., be controlled and responsive status received via a cloud server.

FIG. 2 depicts a cloud server, which may, e.g., be any server with ability to communicate via communication mechanisms like message queuing telemetry transport (MQTT) with the edge engine. Further depicted in FIG. 2 are: an update repository, for edge devices; and an app store repository, for container repositories that include images for locally-developed applications (e.g., implementing AI), images for qualified and validated applications from third parties, and images for the edge device's firmware. Access to these repositories may be setup by the edge engine (e.g., via key exchange with a trusted device, which may be the edge engine of the edge device, such that containerized applications and/or containerized firmware updates are securely deployed and/or securely updated).

In some embodiments, access to the repositories may be controlled using keys, including granular control over how those keys are used. For example, there may be a handshake between a trusted device in edge engine 110 and a request from cloud server 101 to have access to specific keys providing access. In this or another example, based on a kind of device edge device 145 is and based on credentials stored in flash thereof, the keys may be obtained to gain access to whatever this device needs.

In some embodiments, the aforementioned wrapper around docker engine 120 may resolve security issues, e.g., via use of keys. For example, contemplated key management may involve edge engine 110 informing cloud server 101 of one or more identifiers of its device, to then request the appropriate keys for accessing a set of files edge device 145 is entitled to obtain.

Further depicted in FIG. 2 is the device update package, which may contain a payload that can be extracted and deployed by the edge engine to deploy updates to internal device firmware. Still further depicted in FIG. 2 is the app store application, which may be a containerized application that runs through interaction with edge engine 110 and container engine 120, to deploy validated third party applications on the edge device. The interaction may be the pull, start, stop delete functionality referenced earlier.

In some embodiments, app store app 180 may be a third party app, and pulling this app from app store repository 190 to app store app 140 may be made possible via a coordination between edge engine 110 and docker engine 120. For example, the edge engine may coordinate the pull with the right credentials, coordinate the run step through the docker engine, and have the guardrails up about what this app can do once it is running.

In an example use case, an entity may initially have or may be developing a computer vision (CV)/AI application. And the entity may have knowledge of a development environment or containerization process. The knowledge here may refer to an ability to build their application from source, the ability to build their application inside a container, and/or the ability to deploy their application inside a container.

The example use case may be considered to be implemented successfully by: shipping a “development image” device to the entity, which allows the entity to port an application to a relevant software environment; the entity developing and porting applications, for running in a container on the development device (e.g., which may include using a certain format for metadata development, with the porting activity referenced here pertaining to porting an app from running directly on an OS to running on a container hosted by the OS, including building inside a container with all necessary build dependences, determining the minimum deploy dependencies, adding deploy dependencies to the container, and deploying the application with the deployment container); the entity submitting a working container for qualification/certification (e.g., via a push to a container registry); reviewing the container and requesting any changes for the entity to better conform to requirements of the app store; the entity making any necessary changes (e.g., by updating the container); confirming compliance with the app store rules and/or requirements so that the container may be added to a development workspace on the app store and so that the app may be tagged as certified; and/or the entity deploying and testing the container from app store development workspace on development image. When not using a hardware development kit with the entity's server, the entity may validate expected performance of containerized app store application on a development image. This validation may depend on the app, but may typically include aspects like number of frames per second which can be supported by hardware, number of input camera streams which can be supported, etc. The foregoing porting activity may also refer to modifying an application to enumerate input and output requirements, and mapping to the previously mentioned limitations regarding network access, CPU access, persistent storage, etc. Changes may be required if, for instance, the container expects to write significant portions of disk space which are not available on some hardware embodiments, needs significant CPU resources which are not available on some embodiments, or needs more memory than are available on some embodiments. Changes may also be required if the application requires network access which cannot be guaranteed or cannot be granted in some embodiments, for instance devices on mobile links with bandwidth limitations.

A customer may validate performance of a containerized app store app production image based on a characteristic of the app itself. For example, if the app is counting cars or if the app is performing other functionality, a user may want to verify that, on deployed/production software, expected performance is obtained. The deployed/production image may be configured into a locked down mode, e.g., prohibiting remote re-provisioning of the production image.

Successful implementation may be further characterized, e.g., by either remotely re-provisioning or shipping a new “production image” device to the entity. And the entity's container may be enabled on the app store for purchase/distribution. The entity may then, e.g., direct data from a data API to their data sink. Devices may send data to a central cloud server or on premise server hosted and controlled locally. In some cases, entities may request data to be funneled to their own cloud or on premise server as well. The “direct data” reference here covers this scenario. This may use a protocol like AMQP to stream events from one server hosted locally to another server hosted (e.g., remotely) by the entity. The previously mentioned deployment testing or the entity's performance validation may be performed on a development or production edge device (e.g., an image camera), or a sandbox may be provided for the entity to use to validate (subject to specific requirements of a specific implementation or application).

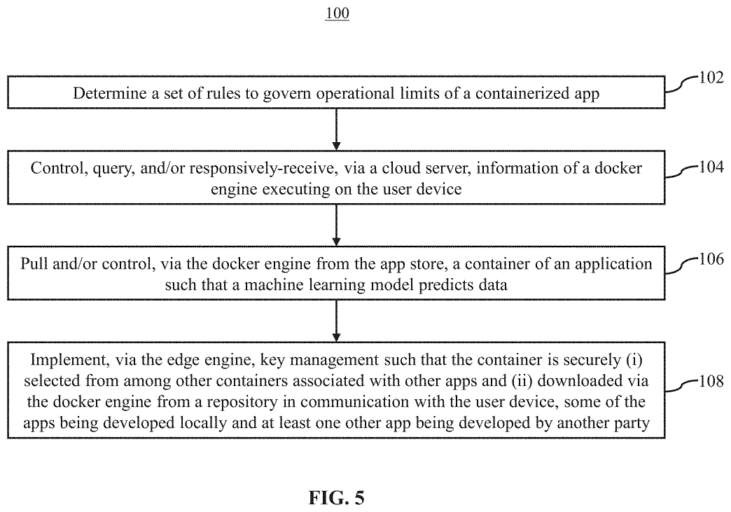

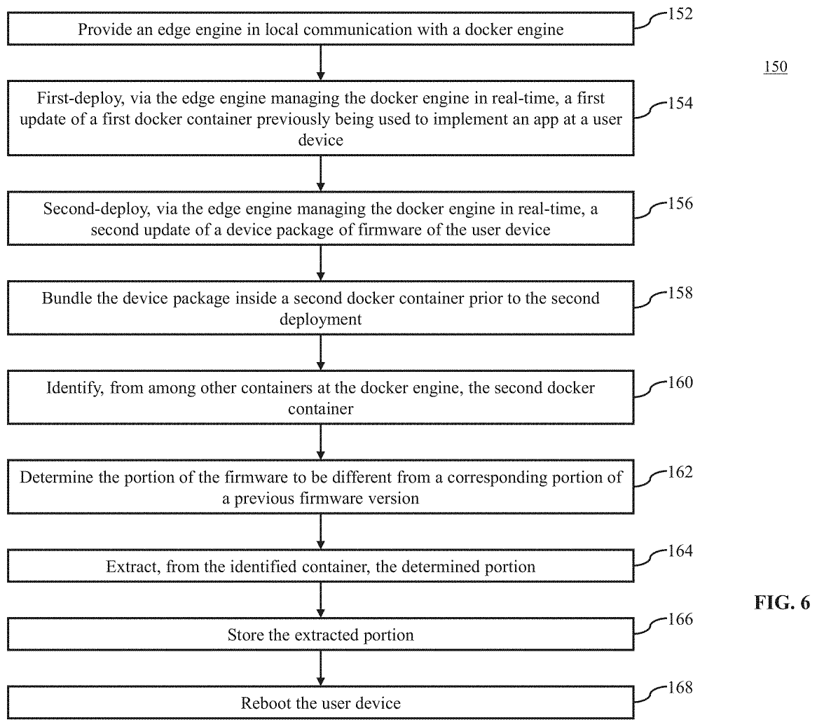

FIG. 5 illustrates method 100 for using docker to implement an app store framework, e.g., being able to run AI in containers, further having means to deploy different containers (e.g., developed by one or more third-party/remote entities and/or by a local party), in accordance with one or more embodiments. FIG. 6 illustrates method 150 for configuring an edge engine to enable a docker engine to support device updates, in accordance with one or more embodiments. Methods 100 and 150 may be performed with a computer system comprising one or more computer processors and/or other components. The processors are configured by machine readable instructions to execute computer program components. The operations of methods 100 and 150 presented below are intended to be illustrative. In some embodiments, methods 100 and 150 may each be accomplished with one or more additional operations not described, and/or without one or more of the operations discussed. Additionally, the order in which the operations of methods 100 and 150 are respectively illustrated in FIGS. 5-6 and described below is not intended to be limiting. In some embodiments, methods 100 and 150 may each be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of methods 100 and 150 in response to instructions stored electronically on an electronic storage medium. The processing devices may include one or more devices configured through hardware, firmware, and/or software to be specifically designed for execution of one or more of the operations of methods 100 and 150.

At operation 102 of method 100, a set of rules may be determined to govern operational limits of a containerized app. In some embodiments, operation 102 is performed by a processor component (e.g., cloud server 101 and/or edge engine 110) shown in FIG. 2 and described herein.

At operation 104 of method 100, information of a docker engine executing on the user device may be controlled, queried, and/or responsively-received, via a cloud server. For example, the controlling of the information may determine operability and/or another guardrail function of a set of applications installed at user device 145. Operability determination would potentially include aspects like (i) did the application start successfully, (ii) is the application sending valid output in response to input, (iii) is the app functioning in a way which does not use excessive CPU, storage or memory resources, and (iv) did the app stop when requested and can it be restarted. In this or another example, system 10 may perform real-time controlling, after deploying edge or IoT device 145. In some embodiments, edge device 145 may be any IoT device connected to cloud server 101. In some embodiments, operation 104 is performed by a processor component (e.g., cloud server 101 and/or edge engine 110) shown in FIG. 2 and described herein.

At operation 106 of method 100, a container of an application may be pulled and/or controlled, via the docker engine from the app store, such that a machine learning model predicts data. As an example, a machine learning algorithm or model may be implemented via docker engine 120 to generate data, such as predictions. In this or another example, aspects of the AI models (e.g., training data and/or deployment data) may be containerized (e.g., at app store repository 190), e.g., with AI software packages or containers being configured to leverage docker. In some embodiments, operation 106 is performed by a processor component (e.g., cloud server 101, edge engine 110, and/or docker engine 120) shown in FIG. 2 and described herein.

At operation 108 of method 100, key management may be implemented, via the edge engine, such that the container is securely (i) selected from among other containers associated with other apps and (ii) downloaded via the docker engine from a repository in communication with the user device, some of the apps being developed locally and at least one other app being developed by another party. The edge engine may query the cloud server, which may direct it to a specific configured application. The edge engine may then configure the docker engine (via previously mentioned docker compose files) to pull the appropriate application containers with the appropriate keys. In some embodiments, operation 108 is performed by a processor component shown in FIG. 2 and described herein.

At operation 152 of method 150, an edge engine may be provided in local communication with a docker engine. In some embodiments, operation 152 is performed by a processor component shown in FIG. 2 and described herein.

At operation 154 of method 150, a first update of a first docker container may be first-deployed, via the edge engine managing the docker engine in real-time, the first docker container being previously used to implement an app at a user device. As an example, system 10 may perform real-time updating of an app's container, after deploying edge or IoT device 145. In this or another example, a container obtained from a third party may be deployed at app store app 140. In some embodiments, operation 154 is performed by a processor component shown in FIG. 2 and described herein.

At operation 156 of method 150, a second update of a device package of firmware of the user device may be second-deployed, via the edge engine managing the docker engine in real-time. As an example, system 10 may perform real-time updating of firmware of edge device 145, after deploying edge or IoT device 145, using content of a docker container. In this or another example, docker engine 120 may pull 165 containers (e.g., update package 161 comprising a device update) from edge device update repository 170 to device update package 130. In some embodiments, operation 156 is performed by a processor component shown in FIG. 2 and described herein.

At operation 158 of method 150, the device package may be bundled inside a second docker container prior to the second deployment. In some embodiments, operation 158 is performed by a processor component shown in FIG. 2 and described herein.

At operation 160 of method 150, the second docker container may be identified, from among other containers at the docker engine. The second container may be identified via a docker compose file which groups all containers/services necessary for an application into one package, as described in the previous comment. In some embodiments, operation 160 is performed by a processor component shown in FIG. 2 and described herein.

At operation 162 of method 150, the portion of the firmware may be determined to be different from a corresponding portion of a previous firmware version. In some embodiments, operation 162 is performed by a processor component shown in FIG. 2 and described herein.

At operation 164 of method 150, the determined portion may be extracted, from the identified container. As an example, payloads may be obtained via docker engine 120, including update packages which may then be extracted by edge engine 110 to update the containers themselves and/or one or more specific components of firmware of edge device 145. In some embodiments, operation 164 is performed by a processor component shown in FIG. 2 and described herein.

At operation 166 of method 150, the extracted portion may be stored. In some embodiments, operation 166 is performed by a processor component shown in FIG. 2 and described herein.

At operation 168 of method 150, the user device may be rebooted. In some embodiments, operation 168 is performed by a processor component shown in FIG. 2 and described herein.

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method for implementing an application (app) distribution store, the method comprising:
performing, via an edge engine of a networked device, at least one of controlling, querying, or receiving information of a container engine running at the networked device, wherein the performance is administered by a remote server;
performing, via the container engine, at least one of pulling or controlling a container of an app, wherein the container is obtained from the app store and includes a trained machine learning model;
running the trained machine learning model configured to generate data; and
outputting data to be displayed at a user interface configured to obtain one or more interactions from a user that cause the administration.

2. The method of claim 1, further comprising:
providing the edge engine in communication with the remote server to implement a wrapper around control mechanisms of the container engine.

3. The method of claim 2, further comprising:
obtaining, via the edge engine, a key such that the container is securely (i) selected from among a plurality of other containers associated with other applications and (ii) downloaded via the container engine from a repository in communication with the networked device, some of the apps being developed locally and one or more other apps being developed by another party.

4. The method of claim 1, wherein the controlling of the information determines operability and/or another guardrail function of a set of applications installed at the networked device.

5. The method of claim 4, wherein the controlling comprises guardrails that dictate how data is obtained at a platform.

6. The method of claim 5, wherein the controlling of the container causes a quality assurance criterion to be satisfied with respect to operation of at least one of the applications of the set.

7. The method of claim 2, wherein the pulling causes deployment of different trained machine learning models, each developed by a different entity.

8. The method of claim 7, wherein the edge engine coordinates with the container engine to enable at least one of the different entities to develop a custom, platform-agnostic application.

9. The method of claim 1, further comprising:
determining a set of rules to govern operational limits of the containerized application.

10. The method of claim 1, wherein the generation is made with respect to output data generated by the networked device.

11. The method of claim 1, wherein the networked device is an Internet of things (IoT) device such that deployment of the model is performed via the Internet.

12. A non-transitory computer-readable medium comprising instructions executable by at least one processor to perform a method, the method comprising:
providing, at a networked device, an edge engine communicably coupled to a container engine, wherein the edge engine manages the container engine in real-time; and
deploying, via the edge engine, an update of a containerized device package of firmware of the networked device such that only a portion of the firmware is updated.

13. The non-transitory computer-readable medium of claim 12, wherein the networked device is an IoT device such that deployment of the model is performed via the Internet.

14. The non-transitory computer-readable medium of claim 12, wherein the edge engine performs the management by implementing a wrapper around control mechanisms of the container engine.

15. A method, comprising:
providing an edge engine in local communication with a container engine; and
first-deploying, via the edge engine managing the container engine in real-time, a first update of a first container previously being used to implement an app at a networked device,
wherein a remote server remotely manages the edge engine.

16. The method of claim 15, further comprising:
second-deploying, via the edge engine managing the container engine in real-time, a second update of a device package of firmware of the networked device,
wherein the second update involves software of the edge engine and other functionality of the networked device, and
wherein the second-deployment is efficiently performed by updating only a portion of the firmware of the networked device.

17. The method of claim 16, further comprising:
bundling the device package inside a second container prior to the second deployment.

18. The method of claim 17, further comprising:
identifying, from among other containers at the container engine, the second container.

19. The method of claim 18, further comprising:
determining the portion of the firmware to be different from a corresponding portion of a previous firmware version;
extracting, from the identified container, the determined portion;
storing the extracted portion; and
rebooting the networked device.

20. The method of claim 16, wherein the efficient deployment is performed by the edge engine coordinating with the container engine to pull only a set of containers comprising the firmware portion.
